(19) United States
(12) Patent Application Publication
(10) Pub. No.: US 2026/0318764 A1
(43) Pub. Date: Oct. 15, 2026

(54) PRESSURE SENSOR DEVICE

(71) Applicant: Murata Manufacturing Co., Ltd., Nagaokakyo-shi (JP)

(72) Inventors: Mami UCHIDA, Nagaokakyo-shi (JP); Mari Ota, Nagaokakyo-shi (JP)

(21) Appl. No.: 19/681,302

(22) Filed: May 19, 2026

Related U.S. Application Data
(63) Continuation of application No. PCT/JP2024/036797, filed on Oct. 16, 2024.

(30) Foreign Application Priority Data
Dec. 19, 2023 (JP) 2023-213756

(51) Int. Cl. G01L 9/00

(52) U.S. Cl. CPC G01L 9/0072

(57) ABSTRACT

A pressure sensor device is provided that includes a first substrate layer, a membrane layer, an electrode layer, and a second substrate layer sequentially laminated. The membrane layer includes a diaphragm, and a peripheral portion that surrounds the diaphragm in a lamination direction. The first substrate layer faces the diaphragm in the lamination direction with a connected space interposed therebetween, the connected space being continuous with an outside through a hole, and the first substrate layer is joined to the peripheral portion. The electrode layer includes a base that faces the diaphragm with a sealed space interposed therebetween, and a guard portion that surrounds the base when viewed in the lamination direction, that is spaced from the base, and that is joined to the peripheral portion. The hole extends through the second substrate layer, the guard portion, and the peripheral portion in the lamination direction, is open to an outside.

### CROSS REFERENCE TO RELATED APPLICATIONS

This application is a continuation of International Application No. PCT/JP2024/036797, filed Oct. 16, 2024, which claims priority to Japanese Patent Application No. 2023-213756, filed Dec. 19, 2023, the entire contents of each of which are hereby incorporated by reference in their entirety.

### TECHNICAL FIELD

The present disclosure relates to a pressure sensor device that detects pressure from the outside.

### BACKGROUND

International Publication No. 2023/032501 describes an example of a pressure sensor device that detects pressure from the outside.

In the pressure sensor device described therein, a base portion and a diaphragm portion face each other with a pressure standard chamber interposed therebetween. When pressure is applied to the diaphragm portion from the outside, the diaphragm portion bends, and a distance between the base portion and the diaphragm portion changes. Thus, the electrostatic capacity between the base portion and the diaphragm portion changes. Based on the change of the electrostatic capacity, the pressure applied to the diaphragm portion is detected.

Moreover, in the pressure sensor device described therein, the diaphragm portion is exposed on the outside of the pressure sensor device through an exposure hole. Thus, foreign matter such as water may adhere to the diaphragm portion. Adhesion of foreign matter to the diaphragm portion may lower pressure detection accuracy.

### SUMMARY OF THE INVENTION

In view of the foregoing, a pressure sensor device is provided that reduces the effects of foreign matter on pressure detection accuracy.

In an exemplary aspect, a pressure sensor device is provided that includes a first substrate layer; a membrane layer laminated on the first substrate layer; an electrode layer laminated on a surface of the membrane layer opposite a surface on which the first substrate layer is disposed; and a second substrate layer laminated on a surface of the electrode layer opposite a surface on which the membrane layer is disposed. In this aspect, the membrane layer includes an electroconductive diaphragm, and a peripheral portion that surrounds the diaphragm when viewed in a lamination direction. The first substrate layer faces the diaphragm in the membrane layer in the lamination direction with a connected space interposed therebetween, the connected space is continuous with an outside through at least one hole, and the first substrate layer is joined to the peripheral portion in the membrane layer. Moreover, the electrode layer includes an electroconductive base that faces the diaphragm in the lamination direction with a sealed space interposed therebetween, and a guard portion that surrounds the base when viewed in the lamination direction, that is spaced from the base, and that is joined to the peripheral portion in the membrane layer. The second substrate layer is joined to the electrode layer, and the at least one hole extends through the second substrate layer, the guard portion in the electrode layer, and the peripheral portion in the membrane layer in the lamination direction. The at least one hole is open to an outside in the second substrate layer, and the at least one hole is open to the connected space in the peripheral portion in the membrane layer.

Accordingly, a pressure sensor device is provide that reduces the effect of foreign matter on pressure detection accuracy.

### BRIEF DESCRIPTION OF DRAWINGS

FIG. 1 is a schematic cross-sectional view of a pressure sensor according to an exemplary embodiment of the present disclosure.

FIG. 2 is a schematic plan view of the pressure sensor device according to the first exemplary embodiment of the present disclosure.

FIG. 3 is a schematic cross-sectional view taken along line A-A in FIG. 2.

FIG. 4 is a schematic cross-sectional view taken along line B-B in FIG. 2.

FIG. 5 is a schematic cross-sectional view describing a method for manufacturing the pressure sensor device according to the first exemplary embodiment of the present disclosure.

FIG. 6 is a schematic cross-sectional view describing a process following the process illustrated in FIG. 5 in the method for manufacturing the pressure sensor device according to the first exemplary embodiment of the present disclosure.

FIG. 7 is a schematic cross-sectional view describing a process following the process illustrated in FIG. 6 in the method for manufacturing the pressure sensor device according to the first exemplary embodiment of the present disclosure.

FIG. 8 is a schematic cross-sectional view describing a process following the process illustrated in FIG. 7 in the method for manufacturing the pressure sensor device according to the first exemplary embodiment of the present disclosure.

FIG. 9 is a schematic cross-sectional view describing a process following the process illustrated in FIG. 8 in the method for manufacturing the pressure sensor device according to the first exemplary embodiment of the present disclosure.

FIG. 10 is a schematic cross-sectional view describing a process following the process illustrated in FIG. 9 in the method for manufacturing the pressure sensor device according to the first exemplary embodiment of the present disclosure.

FIG. 11 is a schematic cross-sectional view describing a process following the process illustrated in FIG. 10 in the method for manufacturing the pressure sensor device according to the first exemplary embodiment of the present disclosure, and taken along line C-C in FIG. 2.

FIG. 12 is a schematic plan view of a pressure sensor device according to a modification example of the first exemplary embodiment of the present disclosure.

FIG. 13 is a schematic cross-sectional view of a pressure sensor device according to a modification example of the first exemplary embodiment of the present disclosure, corresponding to the cross section taken along line A-A in FIG. 2.

FIG. 14 is a schematic cross-sectional view of a pressure sensor device according to a modification example of the first exemplary embodiment of the present disclosure, corresponding to the cross section taken along line A-A in FIG. 2.

FIG. 15 is a schematic cross-sectional view of a pressure sensor device according to a modification example of the first exemplary embodiment of the present disclosure, corresponding to the cross section taken along line A-A in FIG. 2.

FIG. 16 is a schematic plan view of a pressure sensor device according to a second exemplary embodiment of the present disclosure.

FIG. 17 is a schematic cross-sectional view taken along line D-D in FIG. 16.

FIG. 18 is a schematic plan view of a pressure sensor device according to a modification example of the second exemplary embodiment of the present disclosure.

### DETAILED DESCRIPTION OF EMBODIMENTS

Hereafter, examples of the present disclosure are described in accordance with attached drawings. The description given below is provided as exemplary aspects, and is not intended to limit the present disclosure, its application, and its use. The drawings are schematic, and, for example, the dimensional ratios of components may be different from the actual ones. In the description given below, terms indicating specific directions or locations (such as terms including "above", "below", "right", "left", "front", or "rear") may be used as needed for purposes of the description. However, the use of terms indicating specific directions or locations are used to facilitate understanding of the present disclosure with reference to the drawings, and the meanings of these terms are not intended to limit the technical scope of the present disclosure.

### First Exemplary Embodiment

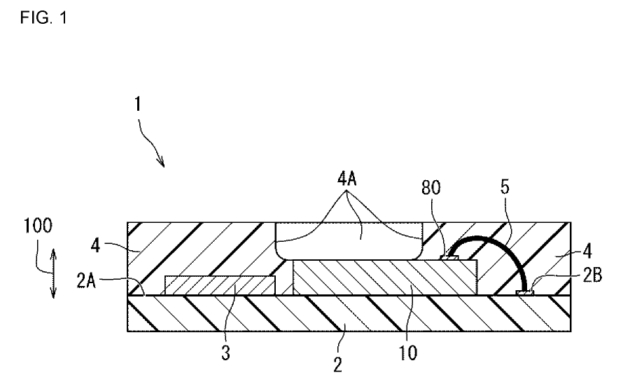

FIG. 1 is a vertical cross-sectional view of a pressure sensor according to a first embodiment of the present disclosure. A pressure sensor 1 is configured to detect pressure, and is mounted on, for example, a movable body such as an automobile, or a consumer device such as a smartphone or a smartwatch.

As illustrated in FIG. 1, the pressure sensor 1 includes a substrate 2, a pressure sensor device 10, an application specific integrated circuit (ASIC) 3, and a resin package 4. Hereafter, the application specific integrated circuit 3 is referred to as an ASIC 3.

The substrate 2 is a plate-shaped member. The substrate 2 is a rigid substrate such as a glass epoxy substrate or a ceramic substrate, but is not limited to this configuration. For example, the substrate 2 may be a lead frame according to an alternative exemplary aspect.

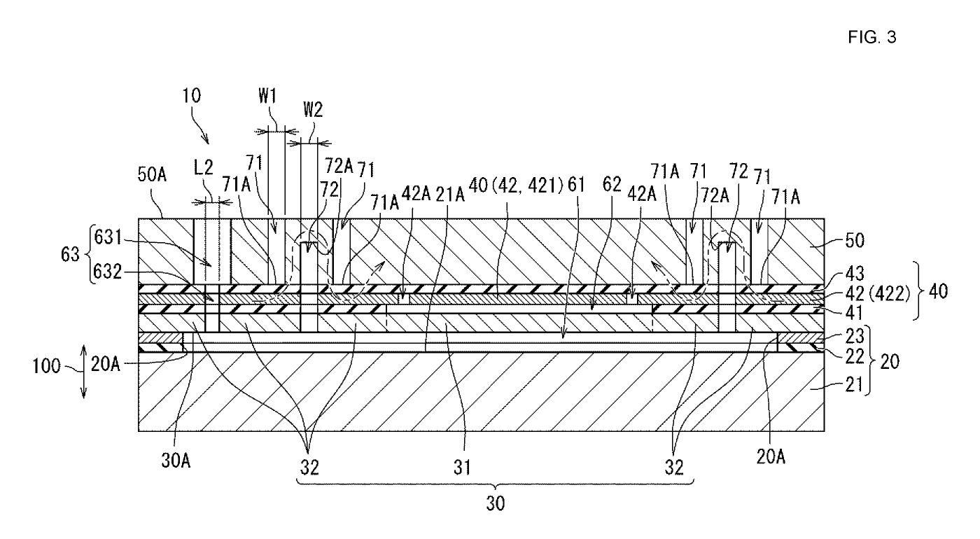

The substrate 2 has a rectangular prism shape that is thin in a lamination direction 100. The lamination direction 100 is a direction perpendicular to an upper surface 2A of the substrate 2. The lamination direction 100 is a direction in which layers included in the pressure sensor device 10 described below are laminated. The layers included in the pressure sensor device 10 are a first substrate layer 20, a membrane layer 30, an electrode layer 40, and a second substrate layer 50 (refer to FIG. 3).

The substrate 2 is quadrangular when viewed in the lamination direction 100. However, the shape of the substrate 2 is not limited to a rectangular prism shape (a quadrangular shape when viewed in the lamination direction 100). For example, the substrate 2 may have a polygonal shape other than a quadrangular shape when viewed in the lamination direction 100 according to an alternative exemplary aspect.

The pressure sensor device 10 detects pressure. The pressure sensor device 10 is an electrostatic capacitive element. In the present disclosure, the pressure sensor device 10 is a micro-electromechanical systems (MEMS) element.

The pressure sensor device 10 is bonded to the upper surface 2A of the substrate 2 with, for example, a die-attach film or a die-attach material. Thus, the pressure sensor device 10 is mounted on the upper surface 2A of the substrate 2. It should be appreciated that the pressure sensor device 10 may be mounted on the substrate 2 by any of various known methods instead of the bonding method described above, as would be appreciated to one of skill in the art.

The pressure sensor device 10 has a rectangular prism shape. However, the shape of the pressure sensor device 10 is not limited to a rectangular prism shape (quadrangular shape when viewed in the lamination direction 100). For example, the pressure sensor device 10 may have a polygonal shape other than a quadrangular shape, or a cylindrical shape when viewed in the lamination direction 100, according to alternative exemplary aspects.

The structure of the pressure sensor device 10 is described later in detail.

The ASIC 3 is mounted on the upper surface 2A of the substrate 2. The ASIC 3 includes a package that covers an integrated circuit. In the first embodiment, the package is formed from silicon, but may be formed from a material other than silicon.

The ASIC 3 is bonded to the upper surface 2A of the substrate 2 with a material such as a die-attach film or a die-attach material. The ASIC 3 is thus mounted on the upper surface 2A of the substrate 2. The ASIC 3 may be mounted on the substrate 2 by any of various known methods instead of the bonding method described above as would be appreciated to one of skill in the art.

The ASIC 3 has a rectangular prism shape. However, the shape of the ASIC 3 is not limited to a rectangular prism shape (a quadrangular shape when viewed in the lamination direction 100). For example, the ASIC 3 may have a polygonal shape other than a quadrangular shape when viewed in the lamination direction 100 according to an alternative exemplary aspect.

The pressure sensor device 10 and the ASIC 3 are electrically connected through bonding wires 5 and the substrate 2. The details are described below. Pads 80 are disposed at the pressure sensor device 10. A pad 2B is disposed at the upper surface 2A of the substrate 2. The pads 80 and the pad 2B are electrically connected with the bonding wires 5. A wiring pattern (not illustrated) is disposed at the upper surface 2A of the substrate 2. The wiring pattern extends from the pad 2B. The ASIC 3 is electrically connected to the pad 2B through the wiring pattern.

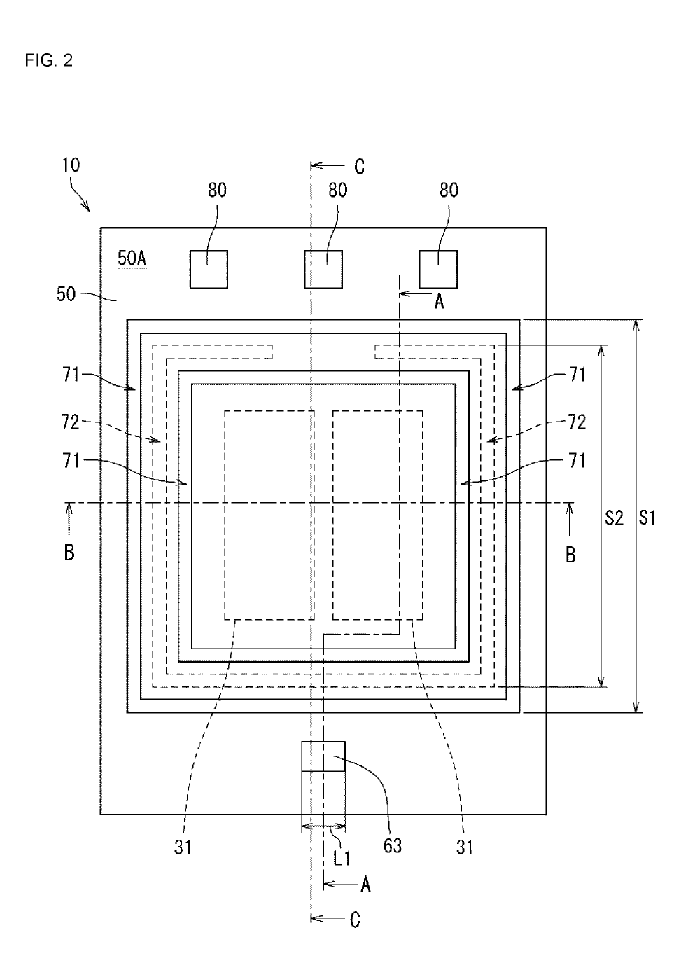

Although FIG. 1 illustrates a single pad 80, a single pad 2B, and a single bonding wire 5 for convenience of description, the pressure sensor 1 may include multiple pads 80, multiple pads 2B, and multiple bonding wires 5. For example, in the first embodiment, the pressure sensor device 10 includes three pads 80 (refer to FIG. 2), and the pads 2B and the bonding wires 5 are provided corresponding to the three pads 80.

It is noted that the structure in which the pressure sensor device 10 and the ASIC 3 are electrically connected is not limited to the above structure. For example, the pressure sensor device 10 and the ASIC 3 may be electrically connected using the bonding wires, without the substrate 2 interposed therebetween, according to alternative exemplary aspects.

The ASIC 3 includes a signal processing circuit that processes a signal output from the pressure sensor device 10, and outputs the processed signal to the substrate 2. For example, the ASIC 3 includes a converter, a filter, temperature sensors, a processor, and a memory. The converter converts a voltage signal output from the pressure sensor device 10 into a digital signal. The filter filters the digital signal from the converter. The temperature sensors detect temperatures. The processor corrects the filtered digital signal based on the detected temperatures from the temperature sensors. The memory stores, for example, correction coefficients used to correct the digital signal using the detected temperatures.

The resin package 4 is formed from resin such as epoxy resin. The resin package 4 is disposed at the upper surface 2A of the substrate 2. The resin package 4 covers the upper surface 2A of the substrate 2, the pressure sensor device 10, the ASIC 3, and the bonding wires 5.

The resin package 4 has an exposure hole 4A. A part of the pressure sensor device 10 is exposed on the outside of the pressure sensor 1 through the exposure hole 4A. In the first embodiment, a part of the pressure sensor device 10 is a portion of an upper surface 50A of the second substrate layer 50 in the pressure sensor device 10, including a hole 63 that is open to the upper surface 50A (refer to FIG. 2 and FIG. 3).

In the first embodiment, as illustrated in FIG. 1, the pressure sensor device 10 and the ASIC 3 are disposed side by side at the upper surface 2A of the substrate 2, but the disposition is not limited to this configuration. For example, the pressure sensor device 10 may be supported on the upper surface of the ASIC 3 according to an alternative exemplary aspect.

The structure of the pressure sensor device 10 is described below.

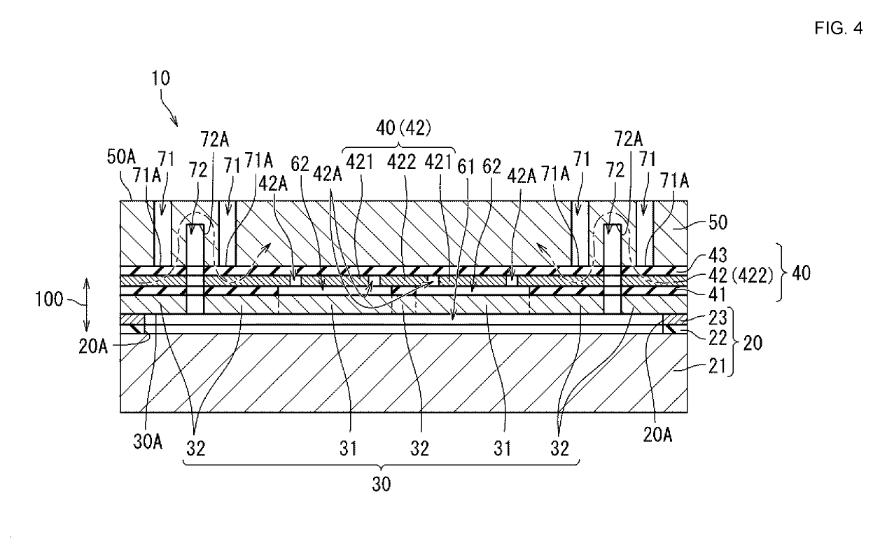

FIG. 2 is a schematic plan view of the pressure sensor device according to the first embodiment of the present disclosure. FIG. 3 is a schematic cross-sectional view taken along line A-A in FIG. 2. FIG. 4 is a schematic cross-sectional view taken along line B-B in FIG. 2.

As illustrated in FIG. 2, FIG. 3, and FIG. 4, the pressure sensor device 10 includes a first substrate layer 20, a membrane layer 30, an electrode layer 40, and a second substrate layer 50.

As illustrated in FIG. 3 and FIG. 4, the membrane layer 30 is laminated on the first substrate layer 20. The electrode layer 40 is laminated on a surface of the membrane layer 30 opposite the surface on which the first substrate layer 20 is disposed. The second substrate layer 50 is laminated on a surface of the electrode layer 40 opposite the surface on which the membrane layer 30 is disposed.

The first substrate layer 20 includes a guard layer 21, a first insulating layer 22, and a first electroconductive layer 23. The first insulating layer 22 is laminated on the guard layer 21. The first electroconductive layer 23 is laminated on a surface of the first insulating layer 22 opposite the surface on which the guard layer 21 is disposed. When viewed in the lamination direction 100, the first insulating layer 22 and the first electroconductive layer 23 are disposed at a peripheral portion of the first substrate layer 20. Thus, when viewed in the lamination direction 100, a portion on the inner side from the peripheral portion is recessed in the lamination direction 100. This recessed portion serves as a connected space 61. The connected space 61 is defined by an upper surface 21A of the guard layer 21, inner surfaces 20A of the first insulating layer 22 and the first electroconductive layer 23, and a lower surface 30A of the membrane layer 30.

In the first embodiment, the thickness of the first substrate layer 20, or in other words, the dimension of the first substrate layer 20 in the lamination direction 100 is 100 to 300 μm.

In the first embodiment, the guard layer 21 is formed from electroconductive silicon (Si), the first insulating layer 22 is formed from electrically insulating silicon dioxide (SiO₂), and the first electroconductive layer 23 is formed from electroconductive polysilicon (Poly-Si).

The membrane layer 30 includes diaphragm portions 31 and a peripheral portion 32.

Both surfaces of the diaphragm portions 31 in the lamination direction 100 are not in contact with other layers in the pressure sensor device 10. In other words, both surfaces of the diaphragm portions 31 in the lamination direction 100 face the space. More specifically, a first surface of the diaphragm portions 31 in the lamination direction 100 faces the connected space 61. More specifically, the diaphragm portions 31 and the guard layer 21 of the first substrate layer 20 face in the lamination direction 100 with the connected space 61 interposed therebetween. In addition, a second surface of the diaphragm portions 31 in the lamination direction 100 faces a sealed space 62, described later. Thus, the diaphragm portions 31 can be configured to bend in the lamination direction 100.

When viewed in the lamination direction 100, the peripheral portion 32 surrounds the diaphragm portions 31. The peripheral portion 32 is integrated with the diaphragm portions 31.

In the peripheral portion 32, both surfaces of the membrane layer 30 in the lamination direction 100 are at least partially in contact with other layers in the pressure sensor device 10. In the present embodiment, a part of the first surface of the peripheral portion 32 in the lamination direction 100 is joined to the first electroconductive layer 23 of the first substrate layer 20. In addition, the remaining portion other than the part of the first surface of the peripheral portion 32 in the lamination direction 100 faces the connected space 61. The second surface of the peripheral portion 32 in the lamination direction 100 is joined to a second insulating layer 41 of the electrode layer 40.

In the first embodiment, the membrane layer 30 has a thickness of 3 to 5 μm. In the first embodiment, the membrane layer 30 is formed from electroconductive silicon (Si).

The electrode layer 40 includes a second insulating layer 41, a second electroconductive layer 42, and a third insulating layer 43.

The second insulating layer 41 is laminated on the peripheral portion 32 of the membrane layer 30. The second electroconductive layer 42 is laminated on a surface of the second insulating layer 41 opposite the surface on which the membrane layer 30 is disposed. The third insulating layer 43 is laminated on a surface of the second electroconductive layer 42 opposite the surface on which the second insulating layer 41 is disposed.

The second insulating layer 41 is joined to the peripheral portion 32 of the membrane layer 30. The second insulating layer 41 has a through-hole that extends through the second insulating layer 41 in the lamination direction 100. The through-hole forms the sealed space 62. A first end portion of the sealed space 62 in the lamination direction 100 is closed by the diaphragm portions 31 in the membrane layer 30. A second end portion of the sealed space 62 in the lamination direction 100 is closed by the second electroconductive layer 42. The side portion of the sealed space 62 is closed by the second insulating layer 41.

The second electroconductive layer 42 includes a base portion 421 (generally referred to as a “base”) and a guard portion 422 (generally referred to as a “guard”).

The base portion 421 faces the diaphragm portions 31 in the membrane layer 30 in the lamination direction 100 with the sealed space 62 interposed therebetween.

When viewed in the lamination direction 100, the guard portion 422 surrounds the base portion 421. The guard portion 422 is spaced from the base portion 421 with a gap 42A interposed therebetween. The gap 42A is continuous with the sealed space 62. The gap 42A thus forms a part of the sealed space 62. The guard portion 422 is joined to the second insulating layer 41. The second insulating layer 41 also surrounds the base portion 421 when viewed in the lamination direction 100, and is spaced from the base portion 421. The guard portion 422 and the second insulating layer 41 are examples of joints.

The third insulating layer 43 is joined to the base portion 421 and the guard portion 422 in the second electroconductive layer 42.

In the first embodiment, the electrode layer 40 has a thickness of 1 to 5 μm. In the first embodiment, the second electroconductive layer 42 is formed from electroconductive polysilicon (Poly-Si). In the first embodiment, the second insulating layer 41 and the third insulating layer 43 are formed from electrically insulating silicon dioxide (SiO₂).

The second substrate layer 50 is joined to the third insulating layer 43 of the electrode layer 40. In the first embodiment, the second substrate layer 50 has a thickness of 100 to 150 μm. In the first embodiment, the second substrate layer 50 is formed from electroconductive silicon (Si).

It is noted that the materials of layers in the pressure sensor device 10 described above are not limited to the above materials.

As illustrated in FIG. 2, FIG. 3, and FIG. 4, the pressure sensor device 10 has a single hole 63. The connected space 61 is continuous with the outside of the pressure sensor device 10 through the single hole 63. The pressure sensor device 10 may include multiple holes 63, and the connected space 61 may be continuous with the outside of the pressure sensor device 10 through the multiple holes 63.

The hole 63 extends through, in the lamination direction 100, the second substrate layer 50, the third insulating layer 43 of the electrode layer 40, the joint (the guard portion 422 and the second insulating layer 41) of the electrode layer 40, and the peripheral portion 32 of the membrane layer 30. The hole 63 is open to the outside of the pressure sensor device 10 in the upper surface 50A of the second substrate layer 50. The hole 63 is thus exposed on the outside of the pressure sensor device 10. The hole 63 is open to the connected space 61 in the lower surface 30A of the peripheral portion 32. Thus, the connected space 61 is continuous with the outside of the pressure sensor device 10 through the hole 63. As described above, in the upper surface 50A of the second substrate layer 50, the hole 63 is exposed on the outside of the pressure sensor 1 through the exposure hole 4A. The connected space 61 is thus exposed on the outside of the pressure sensor 1 through the hole 63 and the exposure hole 4A.

As illustrated in FIG. 2, when viewed in the lamination direction 100, the hole 63 is rectangular. The hole 63 may have any shape. For example, when viewed in the lamination direction 100, the hole 63 may be circular, elliptical, or triangular, or may be a long hole.

As illustrated in FIG. 3, in the first embodiment, the hole 63 includes a large-diameter portion 631 and a small-diameter portion 632. When viewed in the lamination direction 100, the large-diameter portion 631 has a larger area than the small-diameter portion 632. When viewed in the lamination direction 100, the longest portion in the large-diameter portion 631 has a larger dimension than the longest portion in the small-diameter portion 632. In the first embodiment, the dimension of the longest portion in the large-diameter portion 631 is a dimension of a rectangle in the longitudinal direction when viewed in the lamination direction 100. As in the large-diameter portion 631, the dimension of the longest portion in the small-diameter portion 632 is a dimension of a rectangle in the longitudinal direction when viewed in the lamination direction 100. In the first embodiment, the hole 63 includes two portions with different sizes (the large-diameter portion 631 and the small-diameter portion 632), or in other words, has a stepped portion, but the structure of the hole 63 is not limited to this configuration. For example, the hole 63 may have a constant dimension in the lamination direction 100 according to an alternative exemplary aspect. In other words, the hole 63 may extend straight without a stepped portion in the lamination direction 100. Alternatively, for example, the hole 63 may have two or more stepped portions.

The diaphragm portions 31 in the membrane layer 30 and the base portion 421 in the electrode layer 40 face each other with the sealed space 62 interposed therebetween, and thus electrostatic capacity may occur. The electrostatic capacity is changed by a distance between the diaphragm portions 31 and the base portion 421.

Pressure is applied to the diaphragm portions 31 from the outside of the pressure sensor 1 through the exposure hole 4A and the hole 63. As the pressure increases further, the diaphragm portions 31 bend further toward the sealed space 62. Thus, the distance between the diaphragm portions 31 and the base portion 421 decreases. Thus, the electrostatic capacity that occurs between the diaphragm portions 31 and the base portion 421 increases.

The diaphragm portions 31 and the base portion 421 are electrically connected to the different pads 80 (refer to FIG. 2). In FIG. 2, three pads 80 are supported on the upper surface 50A of the second substrate layer 50, and illustrated as if they are electrically connected to each other through the upper surface 50A. However, the three pads 80 are actually electrically insulated from each other. More specifically, the pad 80 electrically connected to the diaphragm portions 31 and the pad 80 electrically connected to the base portion 421 are electrically insulated from each other.

The ASIC 3 (refer to FIG. 1) calculates the electrostatic capacity that occurs in the diaphragm portions 31 and the base portion 421 based on the voltage or the current between the pad 80 connected to the diaphragm portions 31 and the pad 80 connected to the base portion 421. The ASIC 3 calculates the pressure applied to the diaphragm portions 31 based on the calculated electrostatic capacity.

As illustrated in FIG. 2, FIG. 3, and FIG. 4, the pressure sensor device 10 includes two first trench portions 71 (generally referred to as “first trenches”) and one second trench portion 72 (generally referred to as a “second trench”). It is noted that the number of first trench portions 71 included in the pressure sensor device 10 is not limited to two, and the number of second trench portions 72 included in the pressure sensor device 10 is not limited to one.

According to an exemplary aspect, each of the two first trench portions 71 has a quadrangular loop shape when viewed in the lamination direction 100. In other words, each of the two first trench portions 71 has an endless, loop shape. The second trench portion 72 has a quadrangular loop shape with a part missing, when viewed in the lamination direction 100. In other words, the second trench portion 72 has an open-ended loop shape. In the first embodiment, each of the first trench portions 71 and the second trench portion 72 has a square loop shape when viewed in the lamination direction 100.

It is noted that the shapes of the first trench portions 71 and the second trench portion 72 are not limited to the above shapes. For example, the first trench portions 71 and the second trench portion 72 may have an annular shape according to an alternative exemplary aspect. Alternatively, for example, the first trench portions 71 may have an open-ended loop shape, and the second trench portion 72 may have an endless, loop shape. Alternatively, for example, the first trench portions 71 and the second trench portion 72 may be loop-shaped as a whole when viewed in the lamination direction 100, as a result of multiple linear grooves being arranged side by side at intervals. For example, the first trench portions 71 and the second trench portion 72 may extend, for example, in a straight or curved line instead of a loop shape. The two first trench portions 71 may have different shapes or the same shape. The first trench portions 71 and the second trench portion 72 may have different shapes. For example, the first trench portions 71 may have a loop shape, and the second trench portion 72 may have a linear shape when viewed in the lamination direction 100. The first trench portions 71 and the second trench portion 72 may have the same shape.

In FIG. 2, the two first trench portions 71 and the one second trench portion 72 are drawn at the same width, but the first trench portions 71 and the second trench portion 72 may have different widths in alternative exemplary aspects.

As illustrated in FIG. 3 and FIG. 4, the first trench portions 71 are open to the upper surface 50A of the second substrate layer 50. More specifically, the first trench portions 71 in the second substrate layer 50 are open to the outside of the pressure sensor device 10. The depth direction of the first trench portions 71 corresponds to the lamination direction 100. In the first embodiment, the first trench portions 71 extend through the second substrate layer 50 in the lamination direction 100. Thus, the third insulating layer 43 of the electrode layer 40 forms bottom portions 71A of the first trench portions 71.

In the first embodiment, the depth of the first trench portions 71 corresponds to the dimension of the second substrate layer 50 in the lamination direction 100. However, the depth of the first trench portions 71 is not limited to the dimension of the second substrate layer 50 in the lamination direction 100. The first trench portions 71 may be disposed at at least the second substrate layer 50 among the second substrate layer 50, the third insulating layer 43, the guard portion 422, and the second insulating layer 41 of the electrode layer 40, and the peripheral portion 32 of the membrane layer 30.

For example, the first trench portions 71 do not have to extend through the second substrate layer 50 in the lamination direction 100. In this case, the second substrate layer 50 forms the bottom portions 71A of the first trench portions 71. For example, the first trench portions 71 may extend through the second substrate layer 50, and the third insulating layer 43 and the guard portion 422 of the electrode layer 40. In this case, the second insulating layer 41 of the electrode layer 40 forms the bottom portions 71A of the first trench portions 71. For example, the first trench portions 71 may extend through the second substrate layer 50, and the third insulating layer 43, the guard portion 422, and the second insulating layer 41 of the electrode layer 40, and may extend to the middle of the peripheral portion 32 of the membrane layer 30. In this case, the peripheral portion 32 forms the bottom portions 71A of the first trench portions 71.

As further shown, the second trench portion 72 is open to the lower surface 30A of the peripheral portion 32 of the membrane layer 30. More specifically, the second trench portion 72 in the peripheral portion 32 is open to the connected space 61. The depth direction of the second trench portion 72 corresponds to the lamination direction 100. In the first embodiment, the second trench portion 72 extends through the peripheral portion 32, and the second insulating layer 41, the guard portion 422, and the third insulating layer 43 of the electrode layer 40, and extends to the middle of the second substrate layer 50. Thus, the second substrate layer 50 forms a bottom portion 72A of the second trench portion 72.

It is noted that the depth of the second trench portion 72 is not limited to the depth illustrated in FIG. 3. In the first embodiment, the second trench portion 72 may be disposed at at least the peripheral portion 32 among the peripheral portion 32, the second insulating layer 41, the guard portion 422, and the third insulating layer 43 of the electrode layer 40, and the second substrate layer 50.

For example, the second trench portion 72 may extend through the peripheral portion 32, and the second insulating layer 41 and the guard portion 422 of the electrode layer 40. In this case, the third insulating layer 43 of the electrode layer 40 forms the bottom portion 72A of the second trench portion 72.

In the first embodiment, as illustrated in FIG. 2 and FIG. 3, when viewed in the lamination direction 100, the first trench portions 71 and the second trench portion 72 are located on the outer side of the base portion 421 and the diaphragm portions 31.

In the first embodiment, as illustrated in FIG. 2, when viewed in the lamination direction 100, the second trench portion 72 is held between the two first trench portions 71. Thus, as illustrated in FIG. 3, when viewed in the direction perpendicular to the lamination direction 100, the two first trench portions 71 and the second trench portion 72 are arranged side by side.

As further illustrated in FIG. 3, in the lamination direction 100, the bottom portions 71A of the first trench portions 71 are located closer to the first substrate layer 20 than the bottom portion 72A of the second trench portion 72.

The first trench portions 71 and the second trench portion 72 have the above structure, and thus, as indicated by dot-and-dash arrows in FIG. 3 and FIG. 4, when viewed in the direction perpendicular to the lamination direction 100, the membrane layer 30, the electrode layer 40, and the second substrate layer 50 are arranged in a meandering shape (winding shape) from the outer side to the inner side of the pressure sensor device 10.

In the first embodiment, as illustrated in FIG. 2, when viewed in the lamination direction 100, the area of the hole 63 is smaller than the area of the first trench portions 71 and smaller than the area of the second trench portion 72. When viewed in the lamination direction 100, the area of the hole 63 may be greater than the area of the first trench portions 71 and smaller than the area of the second trench portion 72, or smaller than the area of the first trench portions 71 and greater than the area of the second trench portion 72. When viewed in the lamination direction 100, the area of the hole 63 is, for example, the cross-sectional area of a portion of the hole 63 having the minimum cross-sectional area. In the first embodiment, the portion of the hole 63 having the minimum cross-sectional area corresponds to the small-diameter portion 632 illustrated in FIG. 3. More specifically, the cross-sectional area of the portion of the hole 63 having the minimum cross-sectional area is the cross-sectional area corresponds to the cross-sectional area of the small-diameter portion 632. The cross-sectional area of the small-diameter portion 632 illustrated in FIG. 3 is an area of the small-diameter portion 632 when viewed in the lamination direction 100.

In the first embodiment, as illustrated in FIG. 2, a length L1 of a longest portion of the hole 63 when viewed in the lamination direction 100 is shorter than a short side S1 of a trench portion, in each first trench portion 71, having a rectangular loop shape. The length L1 of the longest portion of the hole 63 when viewed in the lamination direction 100 is shorter than a short side S2 of a trench portion, in the second trench portion 72, having a rectangular loop shape. In the first embodiment, each of the first trench portions 71 and the second trench portion 72 has a square loop shape when viewed in the lamination direction 100, and thus the short side and the long side have the same length.

In the first embodiment, as illustrated in FIG. 3, a length L2 of a longest portion, when viewed in the lamination direction 100, in a minimum portion of the hole 63 having the minimum cross-sectional area is shorter than a width W1 of the first trench portions 71 when viewed in the lamination direction 100. The length L2 is shorter than a width W2 of the second trench portion 72 when viewed in the lamination direction 100. In the first embodiment, the minimum portion of the hole 63 having the minimum cross-sectional area is the small-diameter portion 632. The length L2 may be longer than the width W1 and shorter than the width W2, or shorter than the width W1 and longer than the width W2.

### Method for Manufacturing Pressure Sensor Device

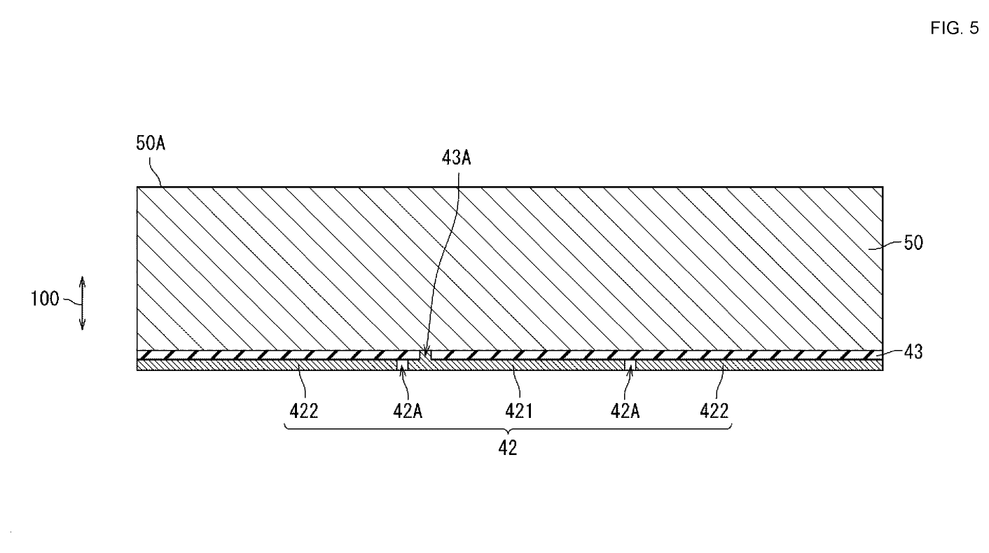

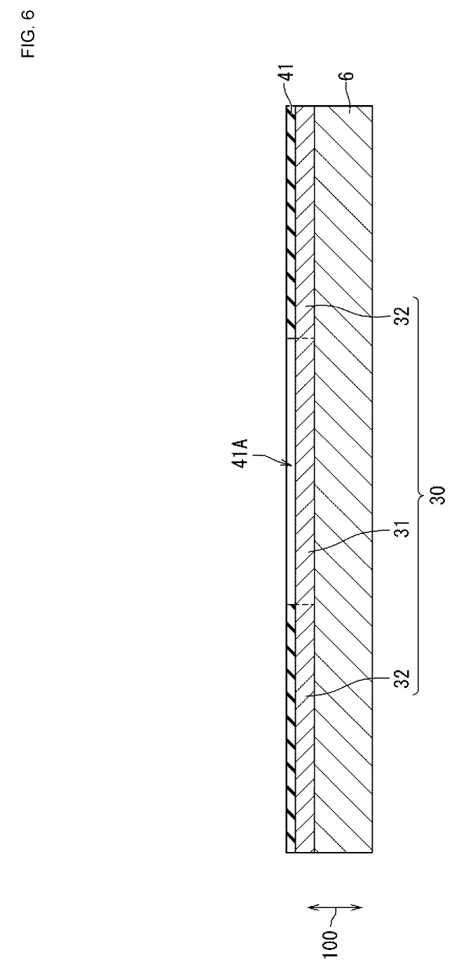

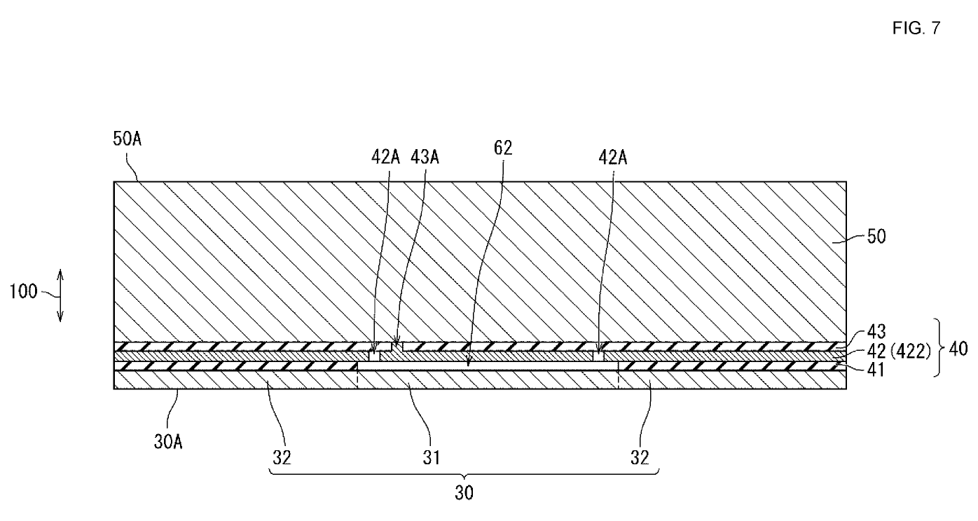

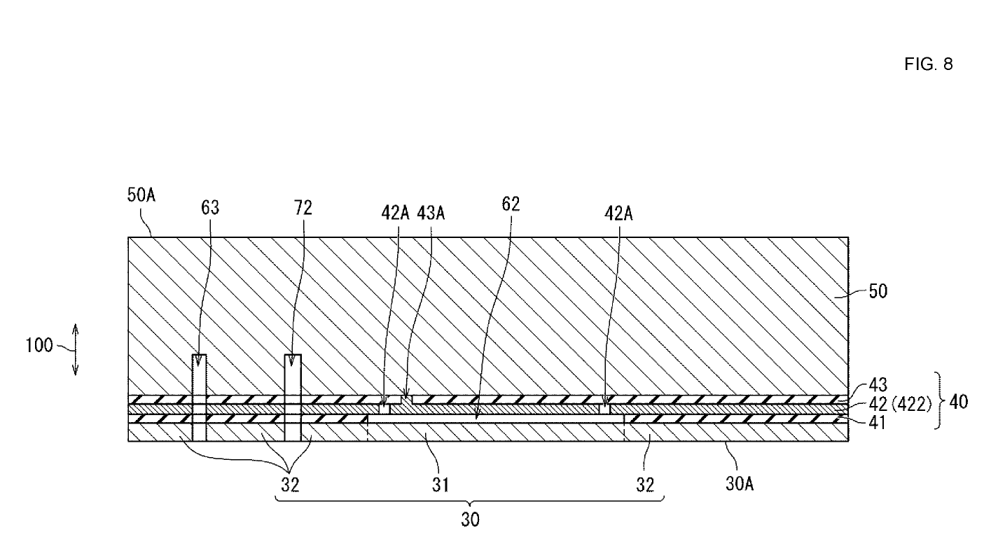

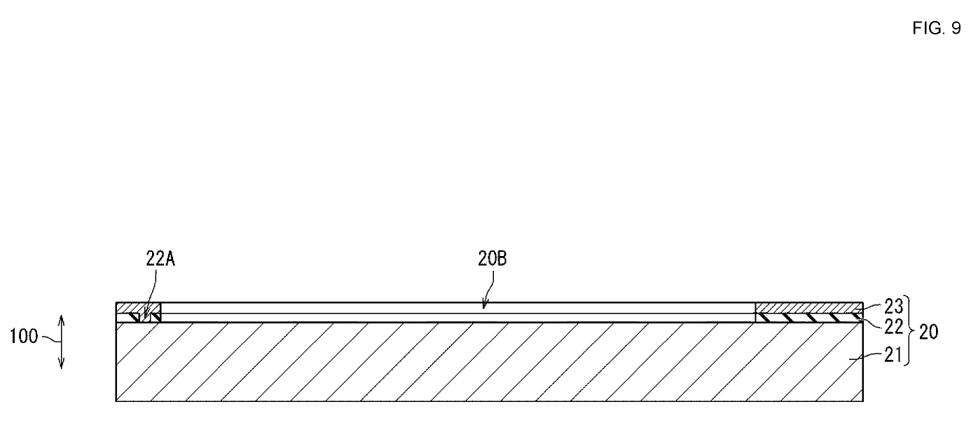

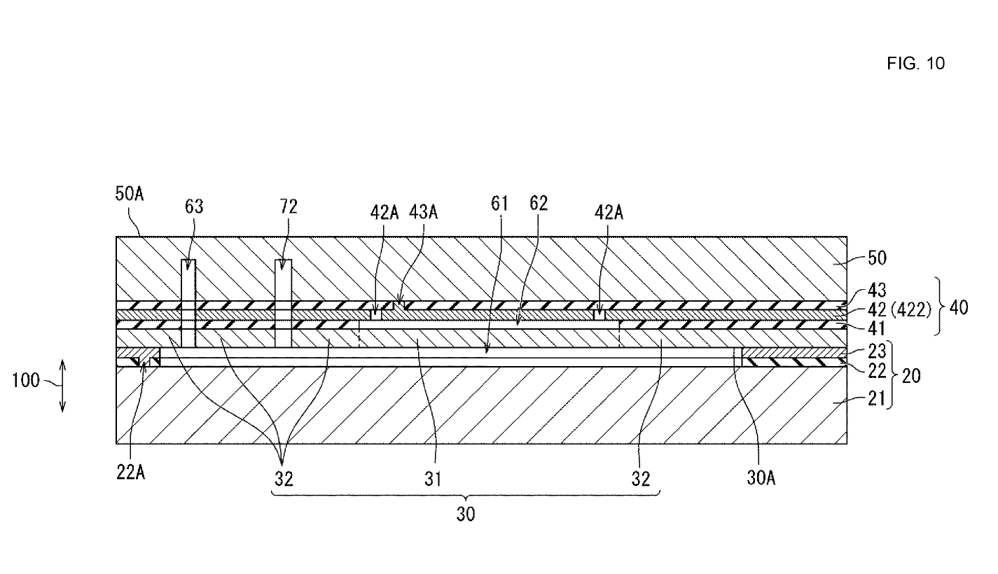

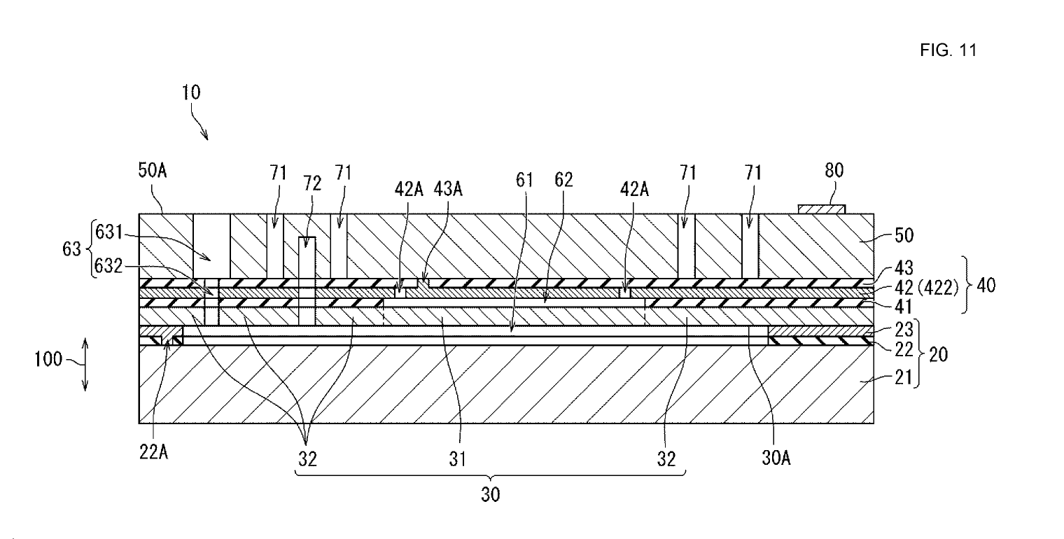

Hereafter, an example of a method for manufacturing the pressure sensor device 10 according to the first embodiment of the present disclosure is described with reference to FIG. 5 to FIG. 11. FIG. 5 is a schematic cross-sectional view for describing a method for manufacturing the pressure sensor device according to the first embodiment of the present disclosure. FIG. 6 is a schematic cross-sectional view for describing a process following the process illustrated in FIG. 5 in the method for manufacturing the pressure sensor device according to the first embodiment of the present disclosure. FIG. 7 is a schematic cross-sectional view for describing a process following the process illustrated in FIG. 6 in the method for manufacturing the pressure sensor device according to the first embodiment of the present disclosure. FIG. 8 is a schematic cross-sectional view for describing a process following the process illustrated in FIG. 7 in the method for manufacturing the pressure sensor device according to the first embodiment of the present disclosure. FIG. 9 is a schematic cross-sectional view for describing a process following the process illustrated in FIG. 8 in the method for manufacturing the pressure sensor device according to the first embodiment of the present disclosure. FIG. 10 is a schematic cross-sectional view for describing a process following the process illustrated in FIG. 9 in the method for manufacturing the pressure sensor device according to the first embodiment of the present disclosure. FIG. 11 is a schematic cross-sectional view for describing a process following the process illustrated in FIG. 10 in the method for manufacturing the pressure sensor device according to the first embodiment of the present disclosure, taken along line C-C in FIG. 2.

In an exemplary aspect, the pressure sensor device 10 is manufactured by dicing a multilayer body into pieces. The multilayer body is an integrated body in which multiple pressure sensor devices 10 are arrayed. In FIG. 5 to FIG. 11, for convenience of description, only a portion of the multilayer body corresponding to one pressure sensor device 10 is illustrated. In the manufacturing method described below, three silicon substrates (i.e., the guard layer 21, the membrane layer 30, and the second substrate layer 50) are joined to each other with an insulating layer or an electroconductive layer interposed therebetween, and thus the pressure sensor device 10 is manufactured.

### First Deposition Process

First, a first deposition process is performed. In the first deposition process, as illustrated in FIG. 5, the third insulating layer 43 is deposited on the second substrate layer 50 formed from a silicon substrate, and patterned, and the second electroconductive layer 42 is deposited on the third insulating layer 43 and patterned. With this process and other processes described later, deposition and patterning are performed with a known method, such as photolithography, as would be appreciated to one of skill in the art. Patterning of the third insulating layer 43 forms a gap 43A. Patterning of the second electroconductive layer 42 forms the gap 42A. Thus, the second electroconductive layer 42 is divided into the base portion 421 and the guard portion 422. During deposition of the second electroconductive layer 42, the second electroconductive layer 42 enters the gap 43A. Thus, the second substrate layer 50 and the second electroconductive layer 42 are electrically connected.

### Second Deposition Process

Subsequently, a second deposition process is performed. In the second deposition process, as illustrated in FIG. 6, the second insulating layer 41 is deposited on the membrane layer 30 formed from a silicon substrate, and patterned. Patterning forms an undeposited portion 41A. The undeposited portion 41A is formed into the sealed space 62 in a first joining process described later. A portion of the membrane layer 30 that faces the undeposited portion 41A without in contact with the second insulating layer 41 serves as the diaphragm portions 31, and a portion of the membrane layer 30 that is in contact with the second insulating layer 41 serves as the peripheral portion 32. To secure the thickness, the membrane layer 30 is laminated on a handle layer 6. The second deposition process may be performed before the first deposition process, or performed in parallel with the first deposition process.

### First Joining Process

The first joining process is then performed. In the first joining process, as illustrated in FIG. 7, the second substrate layer 50 and the membrane layer 30 are joined with the second insulating layer 41, the second electroconductive layer 42, and the third insulating layer 43 interposed therebetween. More specifically, the second electroconductive layer 42 deposited on the second substrate layer 50 and the second insulating layer 41 deposited on the membrane layer 30 are joined. Thus, the undeposited portion 41A (refer to FIG. 6) is covered with the second electroconductive layer 42 to define the sealed space 62. In the first joining process, the handle layer 6 (refer to FIG. 6) is removed. Joining performed in the first joining process and a second joining process described later is a known method, such as fusion bonding, as would be appreciated to one of skill in the art.

### First Etching Process

Subsequently, a first etching process is performed. In the first etching process, as illustrated in FIG. 8, etching is performed in the lamination direction 100 from the peripheral portion 32 of the membrane layer 30. In the first etching process and a second etching process described below, etching is performed by a known method, such as a Bosch method, as would be appreciated to one of skill in the art. Thus, the hole 63 and the second trench portion 72 are formed. The hole 63 and the second trench portion 72 thus formed extend through the peripheral portion 32, the second insulating layer 41, the second electroconductive layer 42, and the third insulating layer 43 in the lamination direction 100, and extends to the inside of the second substrate layer 50.

### Third Deposition Process

A third deposition process is then performed. In the third deposition process, as illustrated in FIG. 9, the first insulating layer 22 is deposited on the guard layer 21 and patterned, and the first electroconductive layer 23 is deposited on the first insulating layer 22 and patterned. Patterning of the first insulating layer 22 forms a gap 22A. During deposition of the first electroconductive layer 23, the first electroconductive layer 23 enters the gap 22A. The first electroconductive layer 23 and the guard layer 21 are thus electrically conducted. Patterning of the first insulating layer 22 and the first electroconductive layer 23 forms an undeposited portion 20B. The undeposited portion 20B is formed into the connected space 61 in a second joining process described below.

### Second Joining Process

A second joining process is then performed. In the second joining process, as illustrated in FIG. 10, the membrane layer 30 and the guard layer 21 are joined with the first insulating layer 22 and the first electroconductive layer 23 interposed therebetween. More specifically, the membrane layer 30 is joined to a surface of the first electroconductive layer 23 opposite the surface on which the first insulating layer 22 is disposed. Thus, the undeposited portion 20B (refer to FIG. 9) is covered with the membrane layer 30 to define the connected space 61. At this time, in the membrane layer 30, the entireties of the diaphragm portions 31 and a portion of the peripheral portion 32 are in no contact with the first electroconductive layer 23. The hole 63 and the second trench portion 72 are continuous with the connected space 61. In the second joining process, a surface of the second substrate layer 50 opposite the surface on which the third insulating layer 43 is disposed is ground to adjust the thickness of the second substrate layer 50.

### Second Etching Process

A second etching process is then described. In the second etching process, as illustrated in FIG. 11, etching is performed in the lamination direction 100 from the upper surface 50A of the second substrate layer 50.

Part of etching is performed on a portion overlapping the hole 63, formed in the first etching process, when viewed in the lamination direction 100. Thus, the hole 63 extends through the second substrate layer 50, the third insulating layer 43, the second electroconductive layer 42, the second insulating layer 41, and the peripheral portion 32 in the lamination direction 100. Thus, the connected space 61 is continuous with the outside of the pressure sensor device 10 through the hole 63. The hole 63 formed in the second substrate layer 50 by etching the second substrate layer 50 in the second etching process is the large-diameter portion 631. In contrast, the hole 63 formed in a layer other than the second substrate layer 50 by etching in the first etching process is the small-diameter portion 632.

The remaining part of etching is performed at portions adjacent to the second trench portion 72 formed in the first etching process to hold the second trench portion 72. Thus, the two first trench portions 71 are formed in the second substrate layer 50.

### Pad Forming Process

A pad forming process is then performed. In the pad forming process, as illustrated in FIG. 11, the pads 80 are deposited on the upper surface 50A of the second substrate layer 50 and patterned.

A dicing process is then performed. In the dicing process, a multilayer body in which multiple pressure sensor devices 10 are arrayed is cut to form the separate pressure sensor devices 10.

Hereafter, structures of modification examples of the first embodiment are described. In the description below, components described above are denoted with the same reference signs, and not basically described, or may be described as needed.

### Modification Example

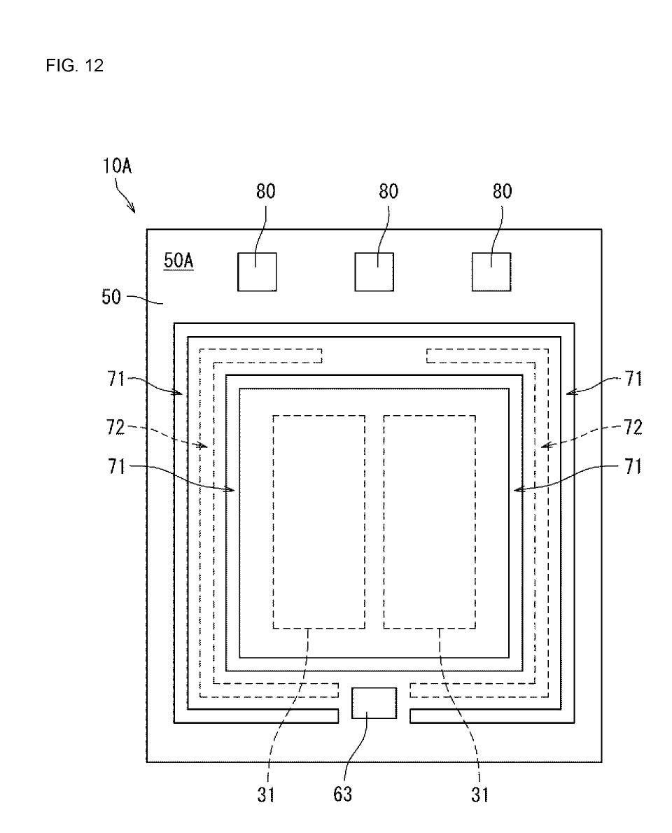

FIG. 12 is a schematic plan view of a pressure sensor device according to a modification example of the first embodiment of the present disclosure.

In the first embodiment, as illustrated in FIG. 2, when viewed in the lamination direction 100, the hole 63 is located on the outer side of the first trench portions 71. However, the hole 63 may be located at a position other than the position illustrated in FIG. 2. For example, as illustrated in FIG. 12, when viewed in the lamination direction 100, the hole 63 may be located at a portion where the first trench portions 71 and the second trench portion 72 are not formed.

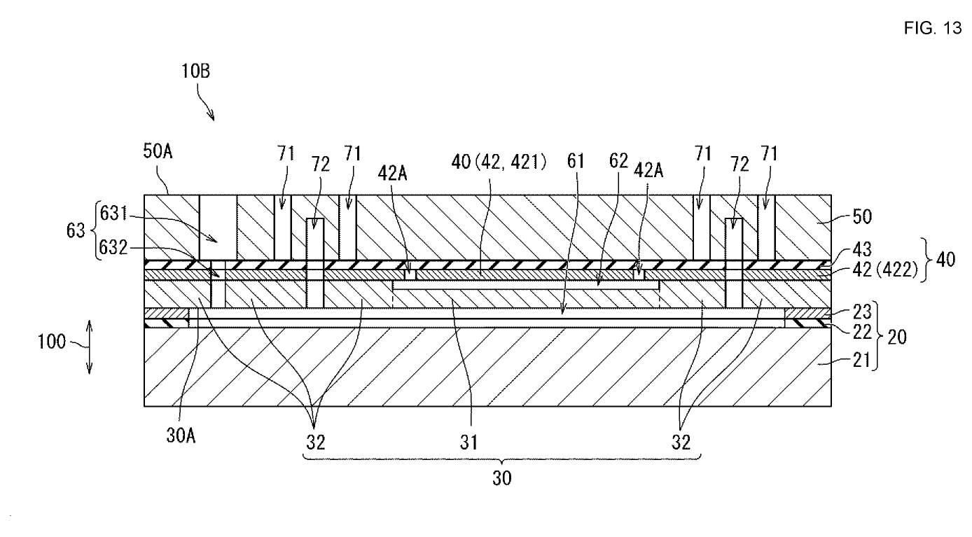

FIG. 13 to FIG. 15 are schematic cross-sectional views of the pressure sensor device according to a modification example of the first embodiment of the present disclosure, corresponding to the cross section taken along line A-A in FIG. 2.

In the structure illustrated in FIG. 3, a stepped portion is formed between the membrane layer 30 and the second insulating layer 41 laminated on the membrane layer 30 to form the sealed space 62. However, the structure of the sealed space 62 is not limited to the structure illustrated in FIG. 3.

For example, as illustrated in FIG. 13 to FIG. 15, a pressure sensor device 10B, 10C, or 10D does not have to include the second insulating layer 41.

In the pressure sensor device 10B illustrated in FIG. 13, the stepped portion is formed between the diaphragm portions 31 and the peripheral portion 32 in the membrane layer 30 to form the sealed space 62.

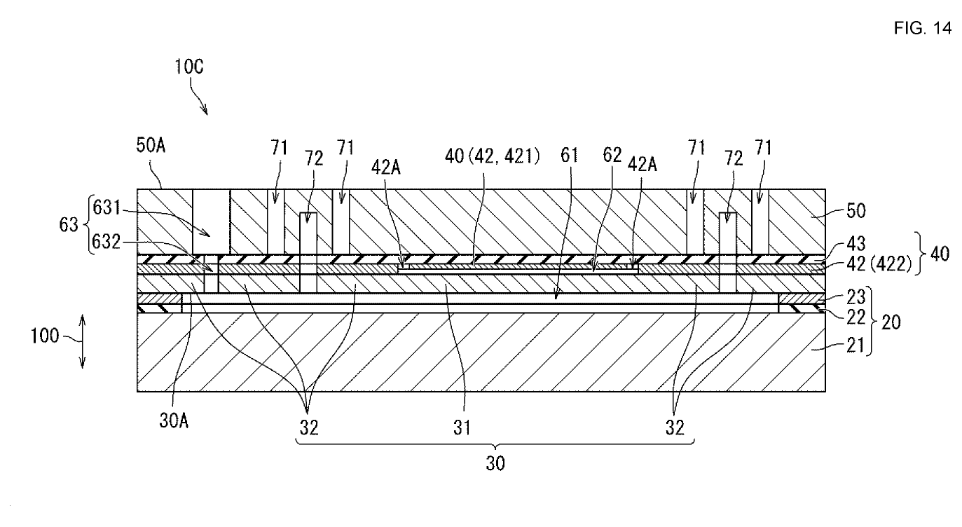

In the pressure sensor device 10C illustrated in FIG. 14, the stepped portion is formed between the base portion 421 and the guard portion 422 in the second electroconductive layer 42 to form the sealed space 62.

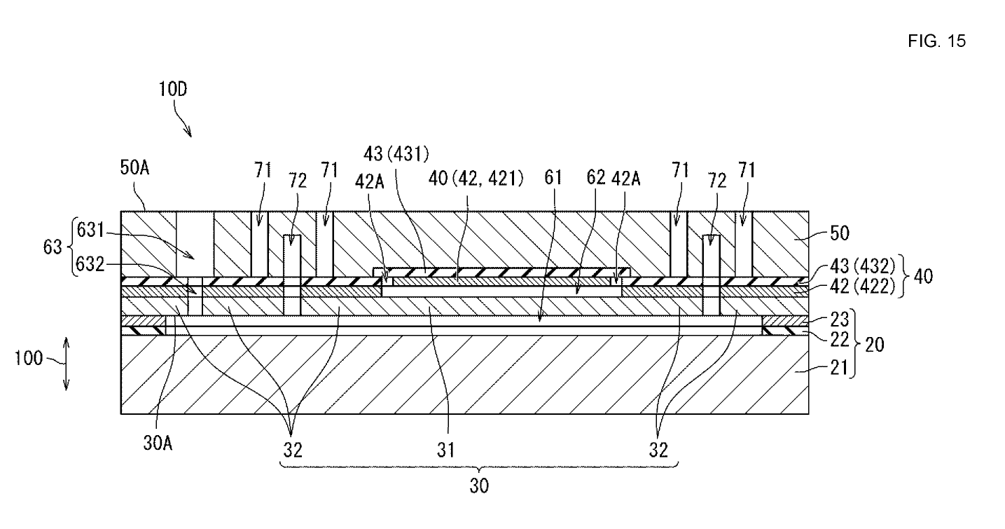

In the pressure sensor device 10D illustrated in FIG. 15, the third insulating layer 43 includes a center portion 431, and a surrounding portion 432 that surrounds the center portion 431 when viewed in the lamination direction 100. A stepped portion is formed between the center portion 431 and the surrounding portion 432, and thus a stepped portion is formed between the base portion 421 and the guard portion 422. The stepped portion between the base portion 421 and the guard portion 422 forms the sealed space 62.

Similarly to the sealed space 62, the connected space 61 may have a structure other than the structure illustrated in FIG. 3.

According to the first embodiment, air can flow through the hole 63 from the outside of the pressure sensor device 10 into the connected space 61. When the pressure of air that has flown into the connected space 61 is applied to the diaphragm portions 31, the diaphragm portions 31 bend toward the base portion 421, and the distance between the base portion 421 and the diaphragm portions 31 is changed. Thus, electrostatic capacity between the base portion 421 and the diaphragm portions 31 is changed. Based on the change of the electrostatic capacity, the pressure applied to the diaphragm portions 31 can be detected.

According to the first embodiment, the base portion 421 is covered with the guard portion 422, the membrane layer 30, and the second substrate layer 50, and is thus not exposed on the outside of the pressure sensor device 10. The diaphragm portions 31 are covered with the peripheral portion 32, the electrode layer 40, and the first substrate layer 20, and are thus not exposed on the outside of the pressure sensor device 10 except for being exposed through the hole 63. Thus, adhesion of foreign matter to the base portion 421 and the diaphragm portions 31 can be reduced.

For example, when foreign matter is liquid and adheres to the diaphragm portions 31, the surface tension of the liquid adhering to the diaphragm portions 31 may affect bending of the diaphragm portions 31. However, according to the first embodiment, adhesion of liquid to the diaphragm portions 31 is reduced, and the effects on bending of the diaphragm portions 31 can be reduced. For example, when foreign matter is water and adheres to the diaphragm portions 31, water adhering to the diaphragm portions 31 may cause an error in the value of electrostatic capacity. However, according to the first embodiment, adhesion of water to the diaphragm portions 31 is reduced, and occurrences of errors in value of electrostatic capacity can be reduced.

When the pressure sensor device 10 includes multiple holes 63, a problem described below may occur. When liquid adheres to the second substrate layer 50 and the opening of a subset of the multiple holes 63 is covered with the liquid, air inside the hole 63 flows out from the openings of the holes 63 not covered with the liquid. Thus, liquid may flow in through the opening of the hole 63 covered with the liquid, reach the connected space 61, and adhere to the diaphragm portions 31. According to the first embodiment, the connected space 61 is continuous with the outside through one hole 63. In this case, when liquid adheres to the second substrate layer 50, regardless of when the opening of one hole 63 is covered with the liquid, air inside the hole 63 does not flow outside. This structure is thus configured to prevent liquid from flowing into the hole 63. Accordingly, this structure is also configured to reduce adhesion of liquid to the diaphragm portions 31.

According to the first embodiment, when viewed in the lamination direction 100, the base portion 421 and the diaphragm portions 31 are located on the inner side of the first trench portions 71 and the second trench portion 72. Thus, the first trench portions 71 and the second trench portion 72 are configured to prevent stress that has occurred in a portion located on the outer side of the first trench portions 71 and the second trench portion 72 when viewed in the lamination direction 100 from acting on the base portion 421 and the diaphragm portions 31. This structure is thus configured to reduce effects of stress on the detection accuracy of the pressure sensor device 10.

According to the first embodiment, when stress that has occurred in a portion located on the outer side of the first trench portions 71 and the second trench portion 72 when viewed in the lamination direction 100 acts on the base portion 421 and the diaphragm portions 31, the propagation path of the stress meanders with the presence of the first trench portions 71 and the second trench portion 72. Thus, the propagation path of the stress is elongated. Thus, propagation of the stress to the base portion 421 and the diaphragm portions 31 is reduced.

According to the first embodiment, the probability of liquid flowing into the hole 63 can be reduced further in a structure where the cross-sectional area at a portion of the hole 63 having the minimum cross-sectional area is greater than the area of the first trench portions 71 when viewed in the lamination direction 100. In addition, the probability of liquid flowing into the hole 63 can be reduced further in a structure where the cross-sectional area at a portion of the hole 63 having the minimum cross-sectional area is greater than the area of the second trench portion 72 when viewed in the lamination direction 100.

According to the first embodiment, the probability of liquid flowing into the hole 63 can be reduced further in a structure where the length L1 of the longest portion of the hole 63 when viewed in the lamination direction 100 is greater than or equal to the short side S1 of the first trench portions 71 having a rectangular loop shape. In addition, the probability of liquid flowing into the hole 63 can be reduced further in a structure where the length L1 of the longest portion of the hole 63 when viewed in the lamination direction 100 is greater than or equal to the short side S2 of the second trench portion 72 having a rectangular loop shape.

According to the first embodiment, the probability of liquid flowing into the hole 63 can be reduced further in a structure where the length L2 of the longest portion of the small-diameter portion 632 serving as a minimum portion when viewed in the lamination direction 100 is greater than or equal to the width W1 of the first trench portions 71. In addition, the probability of liquid flowing into the hole 63 can be reduced further in a structure where the length L2 is greater than or equal to the width W2 of the second trench portion 72.

### Second Exemplary Embodiment

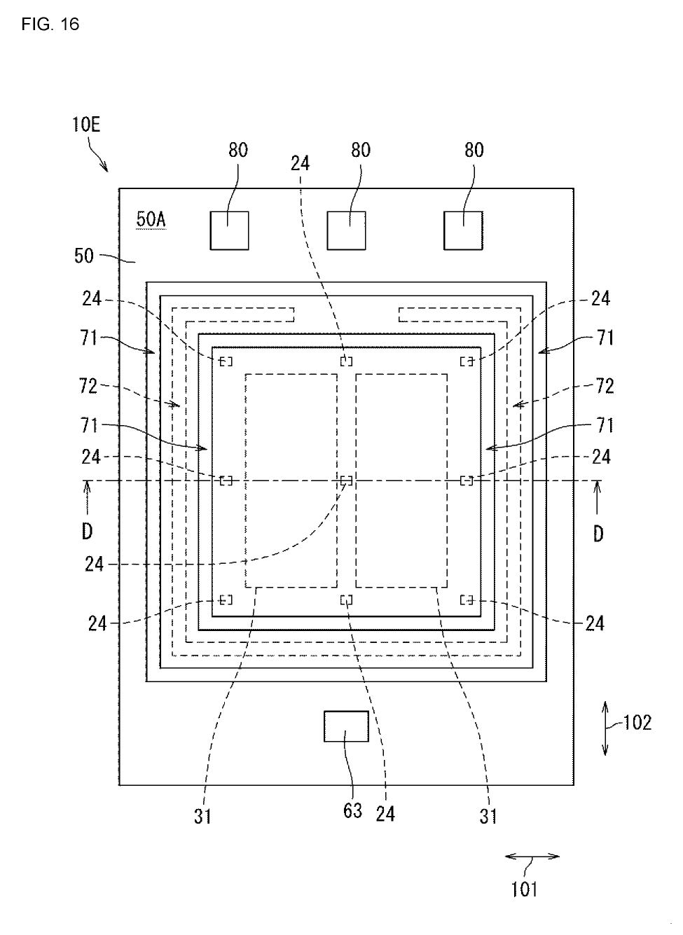

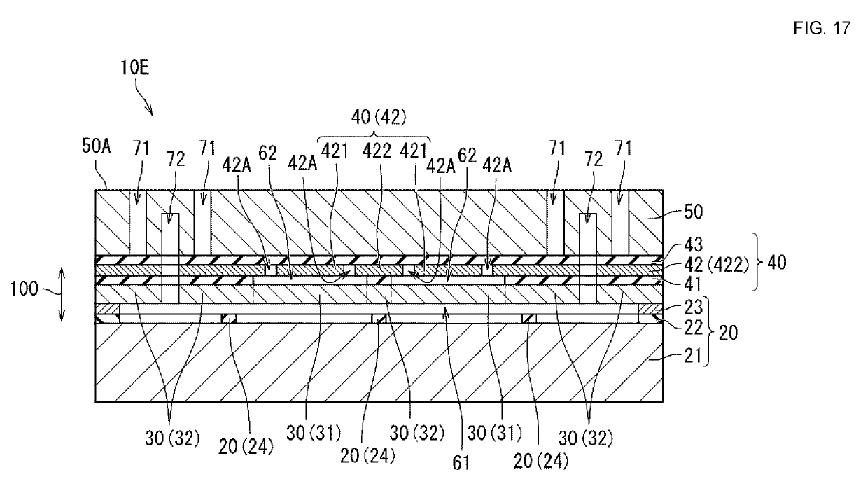

FIG. 16 is a schematic plan view of a pressure sensor device according to a second embodiment of the present disclosure. FIG. 17 is a schematic cross-sectional view taken along line D-D in FIG. 16. The pressure sensor device according to the second embodiment differs from the pressure sensor device according to the first embodiment in that it includes protrusions 24. Hereafter, different points from the pressure sensor device according to the first embodiment are described. The same points as the pressure sensor device according to the first embodiment are denoted with the same reference signs, and not basically described, or may be described as needed.

As illustrated in FIG. 16 and FIG. 17, in a pressure sensor device 10E according to the second embodiment, the first substrate layer 20 includes nine protrusions 24 on parts of the surface facing the connected space 61. Each of the nine protrusions 24 protrudes in the lamination direction 100 toward the membrane layer 30. Each of the nine protrusions 24 is spaced from the membrane layer 30. The nine protrusions 24 are arranged at regular intervals in a first perpendicular direction 101 perpendicular to the lamination direction 100 and a second perpendicular direction 102 perpendicular to both the lamination direction 100 and the first perpendicular direction 101.

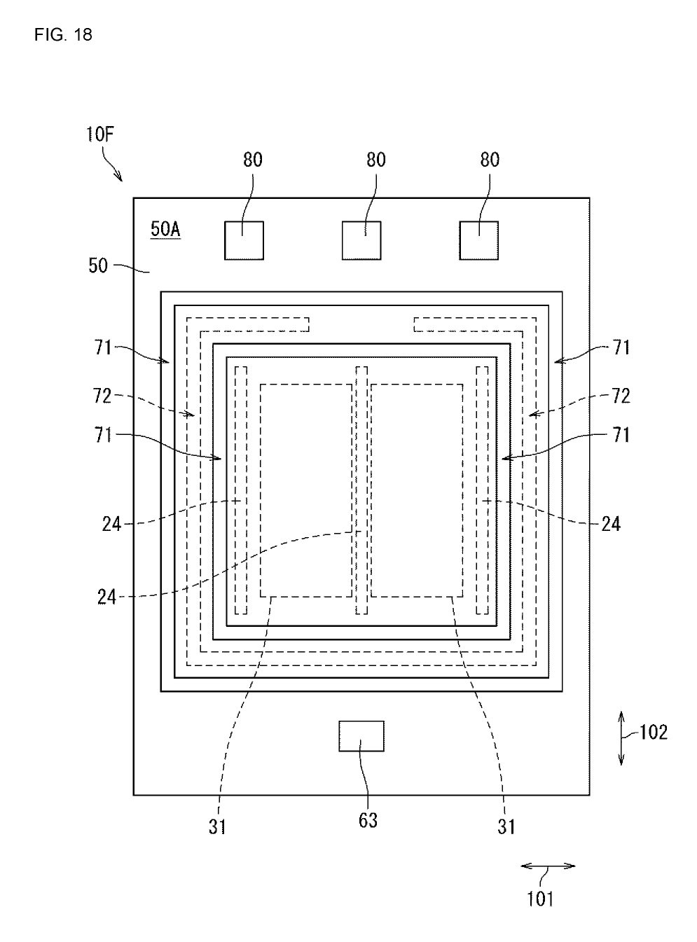

It is noted that the shape and the size of the protrusions 24 are not limited to the shape and the size illustrated in FIG. 16 and FIG. 17. Moreover, the positions of the protrusions 24 are not limited to the positions in FIG. 16 and FIG. 17. The number of protrusions 24 is not limited to nine. For example, as illustrated in FIG. 18, the first substrate layer 20 includes three protrusions 24, and each of the three protrusions 24 may have a linear shape extending in the second perpendicular direction 102 according to an alternative exemplary aspect. FIG. 18 is a schematic plan view of a pressure sensor device according to a modification example of the second embodiment of the present disclosure.

As illustrated in FIG. 16 to FIG. 18, the protrusions 24 have the same shape. However, the protrusions 24 may have different shapes.

For example, in the procedure of manufacturing the pressure sensor device, when pressure is applied to the pressure sensor device from the outside by, for example, pressing of a die, the membrane layer 30, the electrode layer 40, or the second substrate layer 50 may bend. Thus, the diaphragm portions 31 and the first substrate layer 20 may come into contact with each other, and may remain in contact and fail to separate.

According to the second embodiment, the first substrate layer 20 includes the protrusions 24 at parts of the surface facing the connected space 61. Thus, when the diaphragm portions 31 and the first substrate layer 20 are moved closer as a result of bending of the membrane layer 30, the electrode layer 40, and the second substrate layer 50, the diaphragm portions 31 come into contact with the protrusions 24 of the first substrate layer 20. Thus, the contact area between the diaphragm portions 31 and the first substrate layer 20 can be reduced, and the diaphragm portions 31 and the first substrate layer 20 can be easily separated. More specifically, this structure is configured to reduce the probability of the diaphragm portions 31 and the first substrate layer 20 that are in contact remaining in contact and failing to separate.

By combining any two or more of the various embodiments, the effect of each of the embodiments can be exerted.

Although the exemplary aspects of the present disclosure have been fully described in relation to preferred embodiments with reference to the drawings as appropriate, various modifications and alterations will be apparent to those skilled in the art. Such modifications and alterations are to be understood as being included in the scope of the present disclosure , insofar as they do not depart from the scope defined by the appended claims.

### REFERENCE SIGNS LIST

10 pressure sensor device
20 first substrate layer
24 protrusion
30 membrane layer
31 diaphragm portion
32 peripheral portion
40 electrode layer
41 second insulating layer (joint)
421 base portion
422 guard portion (joint)
50 second substrate layer
61 connected space
62 sealed space
63 hole
71 first trench portion
72 second trench portion
100 lamination direction

1. A pressure sensor device comprising:
a first substrate layer;
a membrane layer on the first substrate layer, the membrane layer including an electroconductive diaphragm, and a peripheral portion that surrounds the diaphragm when viewed in a lamination direction;
an electrode layer on a surface of the membrane layer that is opposite a surface on which the first substrate layer is disposed; and
a second substrate layer on a surface of the electrode layer opposite a surface on which the membrane layer is disposed,
wherein the first substrate layer faces the diaphragm in the lamination direction with a connected space interposed therebetween, the connected space being continuous with an outside through at least one hole, and the first substrate layer coupled to the peripheral portion in the membrane layer,
wherein the electrode layer includes:
an electroconductive base that faces the diaphragm in the lamination direction with a sealed space interposed therebetween, and
a guard portion that surrounds the base when viewed in the lamination direction, that is spaced from the base, and that is coupled to the peripheral portion in the membrane layer,
wherein the second substrate layer is coupled to the electrode layer, and
wherein the at least one hole extends through the second substrate layer, the guard portion in the electrode layer, and the peripheral portion in the membrane layer in the lamination direction, the at least one hole is open to an outside in the second substrate layer, and the at least one hole is open to the connected space in the peripheral portion in the membrane layer.

2. The pressure sensor device according to claim 1, wherein the connected space is continuous with an outside through the at least one hole.

3. The pressure sensor device according to claim 1, wherein, among the second substrate layer, the guard portion of the electrode layer, and the peripheral portion of the membrane layer, at least the second substrate layer includes a first trench having a depth direction corresponding to the lamination direction and that is open to the outside in the second substrate layer.

4. The pressure sensor device according to claim 3, wherein, among the second substrate layer, the guard portion of the electrode layer, and the peripheral portion of the membrane layer, at least the peripheral portion of the membrane layer includes a second trench having a depth direction corresponding to the lamination direction and that is open to the connected space in the peripheral portion of the membrane layer.

5. The pressure sensor device according to claim 4, wherein:
when viewed in the lamination direction, the first trench and the second trench are located on an outer side of the base and the diaphragm, and
when viewed in a direction perpendicular to the lamination direction, the first trench and the second trench are arranged side by side, and a bottom of the first trench portion is located closer to the first substrate layer than a bottom of the second trench portion in the lamination direction.

6. The pressure sensor device according to claim 5, wherein a cross-sectional area of a portion of the a least one hole having a minimum cross-sectional area is smaller than an area of the first trench or an area of the second trench when viewed in the lamination direction.

7. The pressure sensor device according to claim 5,
wherein at least one of the first trench or the second trench has a rectangular loop shape when viewed in the lamination direction, and
wherein a length of a longest portion of the at least one hole when viewed in the lamination direction is shorter than a short side of the first trench or the second trench having the rectangular loop shape.

8. The pressure sensor device according to claim 5, wherein a length of a longest portion in a minimum portion of the at least one hole having a minimum cross-sectional area when viewed in the lamination direction is shorter than a width of the first trench when viewed in the lamination direction or a width of the second trench when viewed in the lamination direction.

9. The pressure sensor device according to claim 5, wherein the first substrate layer includes, at a part of a surface facing the connected space, a protrusion that protrudes in the lamination direction toward the membrane layer and that is spaced from the membrane layer.

10. The pressure sensor device according to claim 1, wherein the pressure sensor device is a micro-electromechanical systems (MEMS) electrostatic capacitive element.

11. The pressure sensor device according to claim 1, wherein the membrane layer comprises an electroconductive silicon and has a thickness in the lamination direction between 3 μm to 5 μm, and a dimension of the first substrate layer in the lamination direction is from 100 μm to 300 μm.

12. The pressure sensor device according to claim 1, wherein the first substrate layer comprises a guard layer comprising electroconductive silicon, a first insulating layer comprising silicon dioxide laminated on the guard layer, and a first electroconductive layer comprising electroconductive polysilicon laminated on the first insulating layer, the first electroconductive layer being joined to the peripheral portion of the membrane layer.

13. The pressure sensor device according to claim 12, wherein the electrode layer comprises a second insulating layer joined to the peripheral portion of the membrane layer, a second electroconductive layer laminated on a surface of the second insulating layer opposite the membrane layer, and a third insulating layer laminated on a surface of the second electroconductive layer opposite the second insulating layer.

14. The pressure sensor device according to claim 1, wherein the second substrate layer comprises of electroconductive silicon.

15. The pressure sensor device according to claim 1, wherein the at least one hole comprises a large-diameter portion and a small-diameter portion arranged in the lamination direction so as to define a stepped portion within the hole, the large-diameter portion having a larger cross-sectional area than the small-diameter portion when viewed in the lamination direction, and the large-diameter portion being open to the outside in the second substrate layer.

16. The pressure sensor device according to claim 1, wherein the diaphragm and the base are electrically connected to respective pads that are electrically insulated from each other and supported on a surface of the second substrate layer.

17. The pressure sensor device according to claim 4, wherein the first trench comprises two first trench portions having a quadrangular loop shape when viewed in the lamination direction, and the second trench is between the two first trench portions when viewed in the lamination direction, such that the membrane layer, the electrode layer, and the second substrate layer are arranged in a meandering shape from an outer side toward an inner side of the pressure sensor device when viewed in a direction perpendicular to the lamination direction.

18. The pressure sensor device according to claim 3, wherein the at least one hole is disposed on an outer side of the first portion when viewed in the lamination direction.

19. The pressure sensor device according to claim 1, wherein the electrode layer includes a second electroconductive layer that includes the base and the guard portion, and wherein a stepped portion that forms the sealed space is defined between the diaphragm and the peripheral portion of the membrane layer, between the base and the guard portion of the second electroconductive layer, or between a center portion and a surrounding portion of an insulating layer of the electrode layer that is in contact with the second electroconductive layer.

20. The pressure sensor device according to claim 7, wherein the first substrate layer includes a plurality of the protrusions, each of the plurality of protrusions being spaced from the membrane layer and being arranged at regular intervals along a first perpendicular direction perpendicular to the lamination direction and along a second perpendicular direction perpendicular to both the lamination direction and the first perpendicular direction.
